(19) United States
(12) Patent Application Publication
(10) Pub. No.: US 2007/0129655 A1
(43) Pub. Date: Jun. 7, 2007

(54) Sole reflex massager and its assembly

(76) Inventor: Shin-Kuei Tsai, Taipei (TW)

Correspondence Address: BACON & THOMAS, PLLC, 625 SLATERS LANE, FOURTH FLOOR, ALEXANDRIA, VA, 22314, US

(21) Appl. No.: 11/295,661

(22) Filed: Dec. 7, 2005

(51) Int. Cl. A61H 7/00

(52) U.S. Cl. 601/134; 601/136; 601/27

(57) ABSTRACT

A sole reflex massager comprising a support seat and one or more massage blocks each is detachable and interchangeable, and different massage block has different shaped massage head to provide different strength of excitation; the sole reflex massager is able to be used in single unit or in pair and has interchangeable massage head for varying the shape of massage head so that the user can use the massager in standing posture by employing user's body weight to cause effective excitation on the reflex zone of sole to improve blood circulation to user's body and help excretion of toxicant from user's body, particularly, the user's muscle can get stronger and the user's superfluous fat on thigh can be eliminated by employing the sole reflex massager.

### BACKGROUND OF THE INVENTION

1. Field of the Invention

The invention relates to a sole reflex massager, more particularly to a sole reflex massager special for being used by user in standing posture with whole body weight of the user concentrated on foot to achieve the effect of excitation on reflex zones on sole.

2. Description of the Prior Art

By employing the effect of metabolism human body can excrete the waste or toxicant accumulated in the body. However, if waste and toxicant are continually accumulated inside human body, and are failed to be excreted out of human body, unhealthy and illness will be resulted in.

When in standing posture both human's head and heart are at the farthest distance apart from two feet. Especially the blood circulation of human body is much easier in downward direction but difficult in upward direction, therefore, the feet which are the lowest part of human body are apt to accumulation of waste and toxicant of metabolite. Besides, if there is no foot disease, people normally will not quite pay attention to taking good care of their health that results in the failure of excretion of the waste and toxicant already accumulated in both feet for a long period of time, and influences the normal function of blood circulation and metabolism, and eventually the normal function of human body will be affected, and the cell of human body will gradually degenerate.

However, since the reflex zones on sole are located near the nerve endings, close interlocking relation exists between the reflex zone and the corresponding organ or glands of human body, appropriate excitation or massage against a reflex zone can stimulate and smooth the circulation of blood in the corresponding organ or gland which can further improve the function of metabolism of human body. Therefore, the curative as well as the health care effect can be obtained by giving effective excitation or massage against the reflex zones on human sole.

Though there is the definite curative as well health care effective which can be obtained by giving effective excitation or massage against the reflection zones on sole, the conventional massager presently sold on the market all have the shortcoming that user must be in sitting posture in order to give massage on sole that causes the user unable to apply the required high force on the reflex zone on sole by using the conventional massager. This, in fact, can only give poor effect of massage on sole, and provide only very limited effect in stimulating and smoothing the circulation of blood to improve the function of metabolism.

### SUMMARY OF THE INVENTION

In view of these the major purpose of the invention is to provide a sole reflex massager which is especially designed for being used by the user in the manner of standing on it, so that effective excitation or massage can be achieved by the pressure force due to the own weight of the user concentrated on the specific reflex zone on user's sole. This, in addition to elimination of the shortcoming that user of the massager must be in sitting posture, can also enable a satisfied effect of sole massage to improve the blood circulation and vitalize the cell of human body to prevent the cell from aging, and enhance excretion of toxicant from human body, especially, during the use of the massager, the user must step on the sole reflex massager in standing posture with single foot or both feet to do sole massage, and the user must excite the reflex zone on sole with strength of thigh muscle that can give exercise to and train the thigh muscle, these also enable the sole reflex massager of the invention to possess the effect of helping the user to make thigh muscle more stronger and remove the superfluous fat from thigh.

The minor purpose of the invention is to provide a sole reflex massager which comprises a support seat and a set of detachable and interchangeable massage block which can be used singly or in pair. Each of the detachable and interchangeable massage block has its specific shape design for providing excitation of different strength including flat shape, dome shape and bulge shape that enables the sole reflex massager of the invention to posses the function of varying the strength of excitation by replacing the massage block and the advantage of allowing the user to use it in standing posture to achieve the excitation on the reflex zone on user's sole by user's own weight; particularly the user can select the manner of use based on his/her actual needs either stepping with single foot on the carefully selected massage head of the sole reflex massager with whole body weight concentrated on one foot to generate excitation with a strength able to be endured by the user, or stepping with both feet on two massage heads selected for generating desired excitation mounted on two support seats which are assembled together to form a pair of massage head, and the strength of excitation on the reflection zone on sole caused by user's own weight shall be in such a level that can be endured by the user, and can generate the desired excitation or massage effect.

### BRIEF DESCRIPTION OF THE DRAWINGS

FIG. 1 is the aspect drawing showing the structure of the sole reflex massager of the invention.

FIG. 2 is the schematic drawing of the sole reflex massager in FIG. 1 showing that the massage block is detachable and interchangeable to vary the shape of massage head.

FIG. 3 is the schematic drawing showing the use of the sole reflex massager by stepping on the massager with single foot in standing posture and the whole body weight of user concentrated on single foot to achieve the effect of sole massage.

FIG. 4 is the schematic drawing of the structure of sole reflex massager assembly obtained by assembling together a pair of the sole reflex massager shown in FIG. 1.

FIG. 5 is the schematic drawing of the sole reflex massager assembly showing the use of the massager assembly by a user in standing posture with both feet stepped on the massager assembly to enable sole massage effect by employing the body weight carried by both feet.

### DESCRIPTION OF THE PREFERRED EMBODIMENT

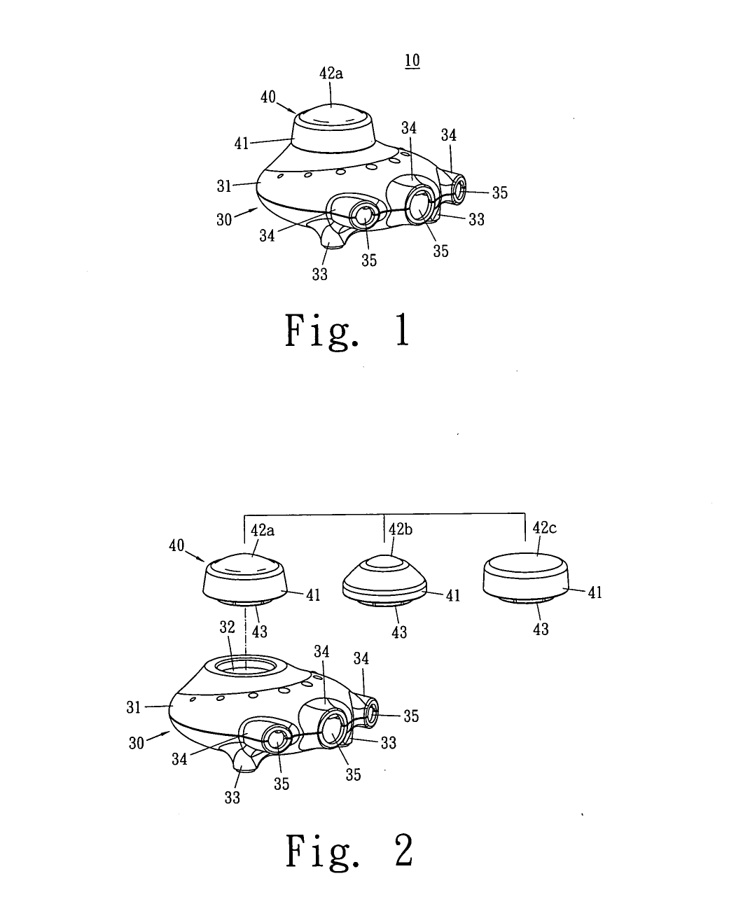

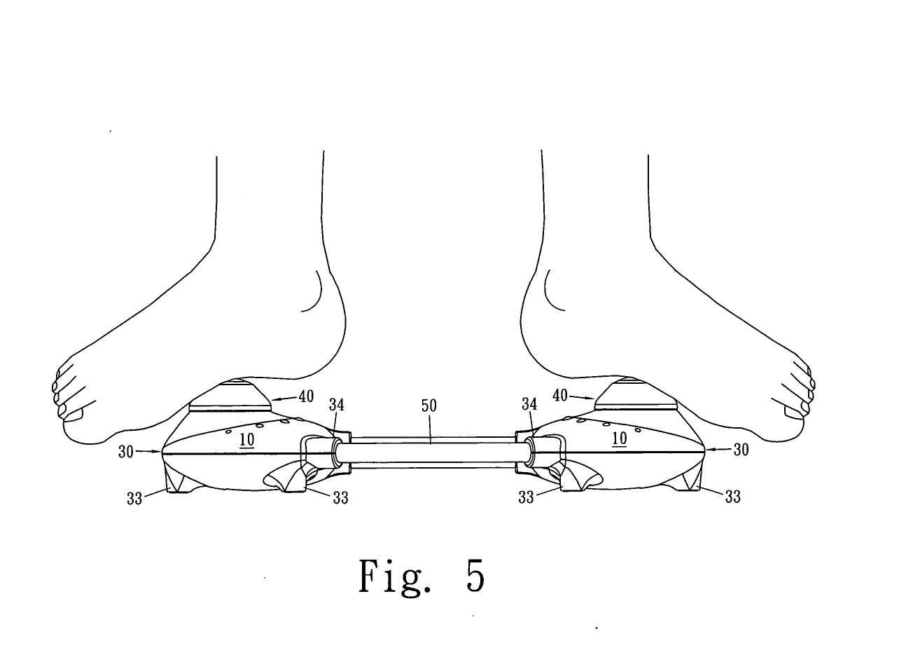

Shown in FIG. 1 through FIG. 3 is a sole reflex massager 10 of the invention designed for being used by the user in standing posture. The user must use single foot to step on the sole reflex massager 10 to have whole body weight of the user concentrated on one foot to cause pressure exerted on the reflex zone on sole for effective excitation and massage. Besides, as shown in FIGS. 4 and 5, a pair of the sole reflex massager 10 of the invention can be combined together to form a sole reflex massager assembly 20 which allows the user to do sole massage in standing posture by employing user's own body weight and stepping on the sole reflex massager with both feet simultaneously.

The basic structure of the sole reflex massager 10 of the invention as shown in FIG. 1 through FIG. 2 comprises a support seat 30 and a massage block 40. However, one of the preferred embodiments of the sole reflex massager of the invention 10 is that a connecting means for connecting the massage block 40 and the support seat 30 is a detachable structure through which different shaped massage block 40 can be interchangeably installed on the support seat 30 to obtain the desired strength of excitation of massage.

Based on the above, as illustrated in FIG. 2, the sole reflex massager of the invention 10 comprises a support seat 30 and one or more interchangeable massage blocks 40, wherein the support seat 30 has a main body 31 which has a strong structure and center of gravity located at lower position suitable for carrying the body weight of a user of common stature. Besides, a connecting recess 32 is formed on top side of the main body 31 for mounting different shaped massage block 40 to obtain different strength of excitation and form the sole reflex massager 10 of the invention.

In addition, on bottom side of the main body 31 appropriate number of foot-stock 33 are formed in such a manner that the center of gravity of the support seat 30 can be arranged in an even lower position, and therefore the support seat 30 can stand on floor more firmly and securely.

The basic structure of the interchangeable massage block 40 has a strong main body 41 and a connecting portion 43 formed on bottom side of the main body 41 shaped corresponding to the connecting recess 32 on top side of the support seat 30. Therefore, different type of massage block 40 can be mounted on the support seat 30 by having the connecting portion 43 of the massage block 40 detachably snapped into the connecting recess 32 of the support seat 30 to form a completed unit of the sole reflex massager 10 of the invention. Similarly, the type of massage block 40 on the support seat 30 can be varied simply by detaching the original massage block 40 and mounting different massage block 40 having different type of massage head to the support seat 30.

As shown in FIG. 2, to enable different massage block 40 to possess different effect of massage, the top portion of the main body 41 of each massage block 40 is designed into specially shaped massage head including dome shape massage head 42a, bulge shaped massage head 42b and flat shaped massage head 42c etc. Based on the specially designed shape of massage head, different massage block 40 carrying different massage head can provide different strength of excitation of massage.

For example, the user steps on a massage block 40 carrying a massage head of bulge shape 42b with single foot, or steps on a massage block 40 carrying a massage head of flat shape 42c will cause different strength of excitation exerted on the reflex zone on sole, i.e., the sole reflex massager 10 of the invention possesses with the function of varying the strength of excitation of massage by detaching and changing the massage block 40.

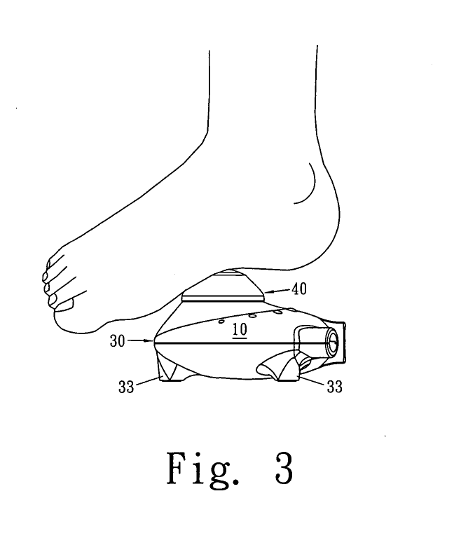

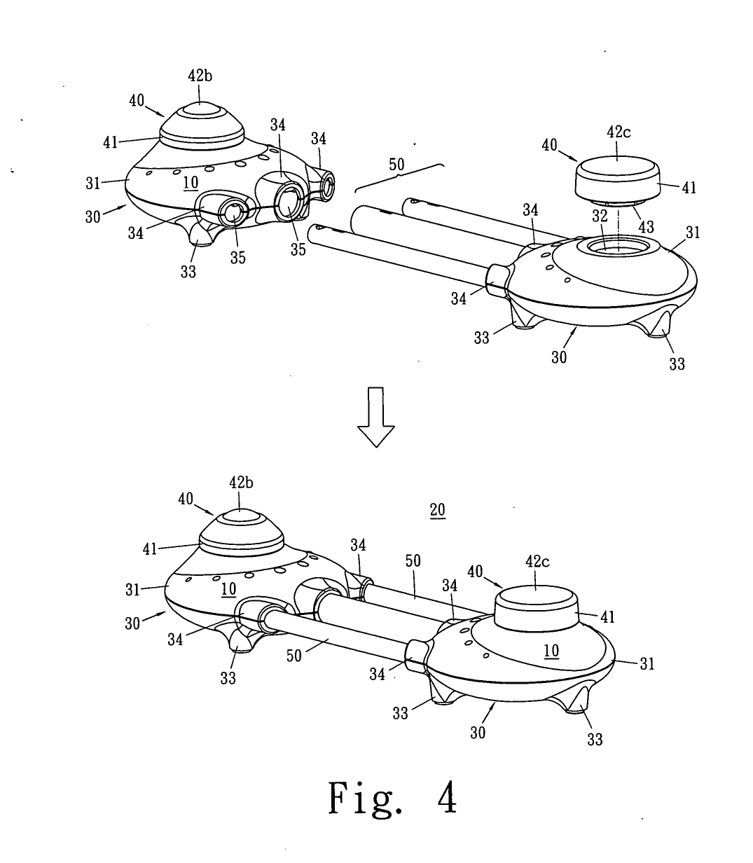

As illustrated in FIG. 3, user can chose massage block 40 with specific massage head suitable for and can be endured by himself/herself, and have the massage block 40 and the support seat 30 assembled together to form the sole reflex massager 10 of the invention. When using the massager 10, the user steps with single foot on the massage block 40 of the sole reflex massager 10 in standing posture the reaction force applied on reflex zone on user's sole by the massage block 40 is due to the own weight of the user, and is sufficient to cause effective excitation on the reflex zone on sole to improve blood circulation and activate the cell of the body, preventing cell from getting aging and enhancing excretion of toxicant from body.

Another preferred embodiment of the invention is as shown in FIGS. 4 and 5; one or more connecting portions 34 may be formed on side wall of the main body 31 of the support seat 30 of the sole reflex massager 10. The connecting portion 34 has a socket 35 provided for mounting a corresponding connecting rods 50 to connect another sole reflex massager 10 to form a sole reflex massager assembly 20 i.e., the sole reflex massager 10 can be used in pair. The user can step on the massage block 40 of paired sole reflex massagers 10 with both feet in standing posture to do sole massage by employing the user's own weight.

Besides, since the sole reflex massager 10 of the invention has the function of able to change the massage block 40 to vary the shape of massage head, user can choose to step on the massage block 40 of a paired sole reflex massage assembly 20 with both feet separately stepping on two different massage heads 40 having different shape for generating different strength of excitation on the reflex zone on sole of both feet.

As depicted in FIG. 5, since the support seat 30 of the sole reflex massager 10 of the invention has a strong and secure structure and center of gravity arranged in even lower position, when the user steps on the massage block 40 of the paired sole reflex massagers 10 in standing posture, and moves both feet with quick short steps on the massage block 40 to shift the body weight cyclically between two feet, the user's own body weight can be firmly supported by each of the two sole reflex massages 10 without tipping over. Moreover since the user's own body weight can be concentrated on either of the two massage blocks 40 of the sole reflex massage 10, and each of the two massage blocks 40 can carry different massage head of different shape formed on top side of the main body 41, effective excitation on the reflex zone on user's sole can be obtained by concentrate body weight on the specially designed massage head to improve blood circulation, activate cell, prevent cell from getting aging and help excretion of toxicant from body.

In addition, when the user steps on the sole reflex massager assembly 20 of the invention in standing posture, and continuously varies the reflex zone on sole being excited, the muscle of thigh also undergoes rigorous training.

Therefore, when using the sole reflex massage assembly 20 in standing posture to do massage on sole to excite the reflex zone, the effect of making thigh muscle stronger and eliminating superfluous fat on thigh can also be achieved.

What is claimed is:

1. A sole reflex massager comprising a support seat and one or more massage blocks, wherein the support seat has a main body with a connecting recess formed on its top side; and each massage block has a main body which has a massage head formed on the top side and a connecting portion formed on the bottom side for being mounted on and detachably snapped into the connection recess of the support seat.

2. The sole reflex massager as described in claim 1, wherein the massage block on its top side is formed with a dome shaped massage head, a bulge shaped massage head, or a flat shaped massage head.

3. The sole reflex massager as described in claim 1, wherein on bottom side of the support seat is formed with foot-stocks.

4. The sole reflex massager as described in claim 2, wherein on bottom side of the support seat is formed with foot-stocks.

5. A sole reflex massage assembly comprising two sole reflex massagers connected by one or more connecting rods, and each sole reflex massager comprises a support seat and one or more massage blocks, wherein
the support seat has a main body with a connecting recess formed on its top side and one or more connection portions formed on its side wall, and each connecting portion has a socket for mounting a corresponding connecting rod; and
each massage block has a main body which has a massage head formed on the top side and a connecting portion formed on the bottom side for being mounted on and detachably snapped into the connection recess of the support seat.

6. The sole reflex massager assembly as described in claim 5, wherein the massage block on its top side is formed with a dome shaped massage head, a bulge shaped massage head, or a flat shaped massage head

7. The sole reflex massager assembly as described in claim 5, wherein on bottom side of the support seat is formed with foot-stocks.

8. The sole reflex massager assembly as described in claim 6, wherein on bottom side of the support seat is formed with foot-stocks.
